(19) United States
(12) Patent Application Publication
(10) Pub. No.: US 2013/0170203 A1
(43) Pub. Date: Jul. 4, 2013

(54) LIGHT-EMITTING DIODE ARRAY LIGHT SOURCE AND OPTICAL ENGINE HAVING THE SAME

(71) Applicants: Kuei-Yuan Cheng, Taoyuan County (TW); Chia-Jen Ting, Hsinchu County (TW); Meng-Chi Huang, Taoyuan County (TW); Hui-Hsiung Lin, Miaoli County (TW); Ta-Hsin Chou, Hsinchu City (TW)

(72) Inventors: Kuei-Yuan Cheng, Taoyuan County (TW); Chia-Jen Ting, Hsinchu County (TW); Meng-Chi Huang, Taoyuan County (TW); Hui-Hsiung Lin, Miaoli County (TW); Ta-Hsin Chou, Hsinchu City (TW)

(73) Assignee: Industrial Technology Research Institute, Hsinchu (TW)

(21) Appl. No.: 13/602,339

(22) Filed: Sep. 4, 2012

(30) Foreign Application Priority Data
Dec. 28, 2011 (TW) 100149273

(51) Int. Cl. F21V 5/04

(52) U.S. Cl. 362/235

(57) ABSTRACT

A light-emitting diode (LED) array light source includes a substrate, a meshed light-shielding layer, LED chips, and a micro-lens array. The meshed light-shielding layer includes bar-shaped light-shielding patterns intersected with one another to define openings. Each bar-shaped light-shielding pattern has a bottom surface, a top surface, and two side surfaces. A width of the top surface is smaller than that of the bottom surface. A thickness of the meshed light-shielding layer is T1. Each LED chip is exclusively located in one of the openings. The micro-lens array covers the substrate, the meshed light-shielding layer, and the LED chips and includes micro-lenses arranged in array. Each micro-lens includes a base portion and a lens portion, and is disposed corresponding to one of the openings, respectively. A vertical distance from a top portion of each micro-lens to the bottom surface is T2, and 0.278≦T1/T2≦0.833.

### CROSS-REFERENCE TO RELATED APPLICATION

The present application is based on, and claims priority from, Taiwan Application Serial Number 100149273, filed on Dec. 28, 2011, the disclosure of which is hereby incorporated by reference herein in its entirety.

### BACKGROUND OF THE DISCLOSURE

1. Technical Field

The disclosure relates to an optical engine, and particularly relates to a light-emitting diode (LED) array light source in the optical engine.

2. Description of Related Art

In recent years, light-emitting efficiency of LED continues to advance, and the LED has replaced fluorescent lamps and incandescent lamps in some fields. Such fields include scanning lamps with high response speed, back light sources or front light sources of light crystal displays (LCDs), light sources for car dashboards, traffic lights, light sources of projection unites, conventional illumination apparatuses, and so on. Specifically, the LED has a service life of more than 100,000 hours and does not require idling time. In addition, the LED has advantages of high response speed (about 10⁻⁹ seconds), small volume, low power consumption, low degree of pollution, high reliability, good adaptation to mass production, and so on. Thus, the LED is extensively applied in various fields.

The LED is a Lambertian-like light source and frequently has the full width at half maximum (FWHM) of light-intensity peak from about 55° to about 60°. In the existing technology, an effective utilization rate of the LED in a projection unit with a light-receiving half angle of 15° merely ranges from about 6% to about 10%. Apparently, collimation and light-emitting efficiency of the existing LED are not satisfactory enough. Hence, how to ameliorate the collimation and the light-emitting efficiency of the LED without significantly increasing the volume and the weight of the light source has become a focus to researchers and designers in this field.

### SUMMARY

In the disclosure, an LED array light source including a substrate, a meshed light-shielding layer, a plurality of LED chips, and a micro-lens array is provided. The meshed light-shielding layer is disposed on the substrate and includes a plurality of bar-shaped light-shielding patterns intersected with one another to define a plurality of openings arranged in array. Each of the bar-shaped light-shielding patterns has a bottom surface in contact with the substrate, a top surface, and two side surfaces, a width of the top surface is smaller than a width of the bottom surface, and a thickness of the meshed light-shielding layer is T1. Each of the LED chips is exclusively located in one of the openings and disposed on the substrate. The micro-lens array covers the substrate, the meshed light-shielding layer, and the LED chips and includes a plurality of micro-lenses arranged in array. Each of the micro-lenses respectively includes a base portion in contact with the meshed light-shielding layer and a lens portion connected to the base portion, and each of the micro-lenses is disposed corresponding to one of the openings, respectively. A vertical distance from a top portion of each of the micro-lenses to the bottom surface is T2, and 0.278≦T1/T2≦0.833.

In the disclosure, an optical engine including the aforesaid LED array light source and a projection unit is further provided. The LED array light source serves to provide a light beam, and the projection unit is disposed on a transmission path of the light beam. Besides, a light-receiving half angle of the projection unit is approximately 15°.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating an optical engine according to an exemplary embodiment of the disclosure.

FIG. 2 is a schematic cross-sectional diagram illustrating an LED array light source according to an exemplary embodiment of the disclosure.

FIG. 3A to FIG. 3C are schematic cross-sectional diagrams illustrating three different LED array light sources.

FIG. 4A and FIG. 4B illustrate light intensity distribution in an LED chip according to an exemplary embodiment of the disclosure.

### DETAILED DESCRIPTION OF DISCLOSED EMBODIMENTS

The disclosure is directed to an LED array light source with favorable light-emitting efficiency.

The disclosure is further directed to an optical engine with favorable display quality.

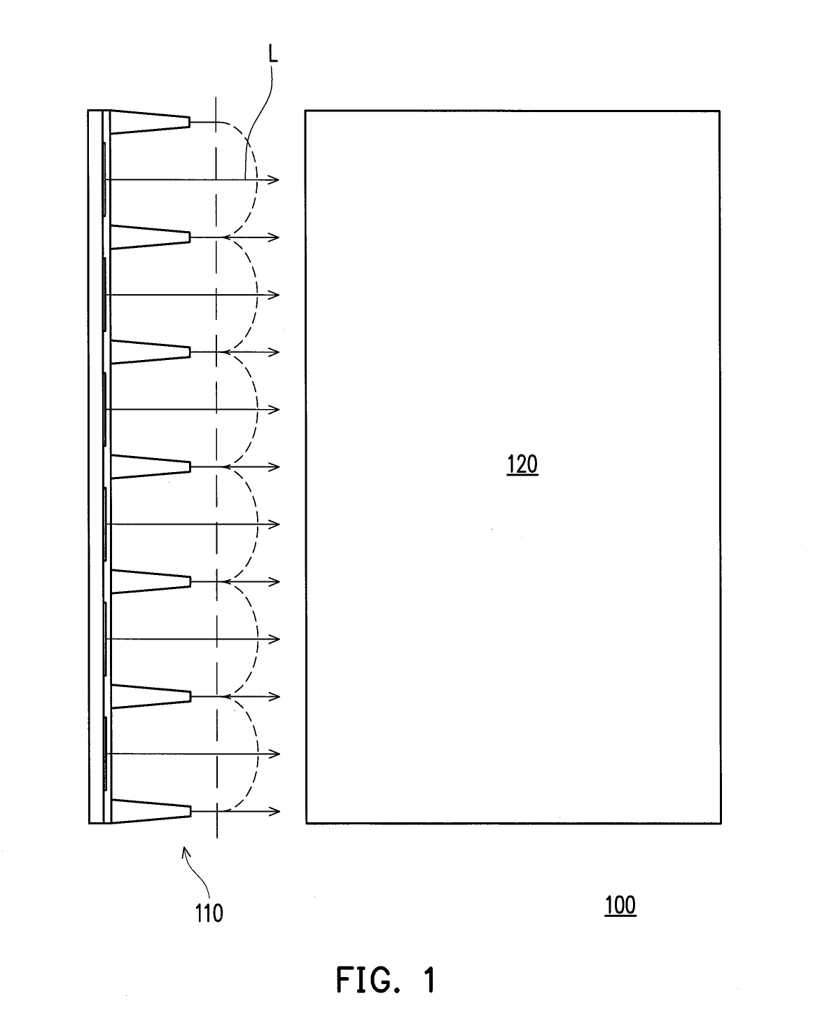

FIG. 1 is a schematic diagram illustrating an optical engine according to an exemplary embodiment of the disclosure. With reference to FIG. 1, an optical engine 100 in the present embodiment includes an LED array light source 110 and a projection unit 120. The LED array light source 110 serves to provide a light beam L, and the projection unit 120 is disposed on a transmission path of the light beam L. Besides, a light-receiving half angle of the projection unit 120 is approximately 15°. In the present embodiment, the projection unit 120 may have any optical design and should not be limited in the disclosure. It should be mentioned that the optical engine 100 in the present embodiment may be applied to micro-projection of a portable electronic device.

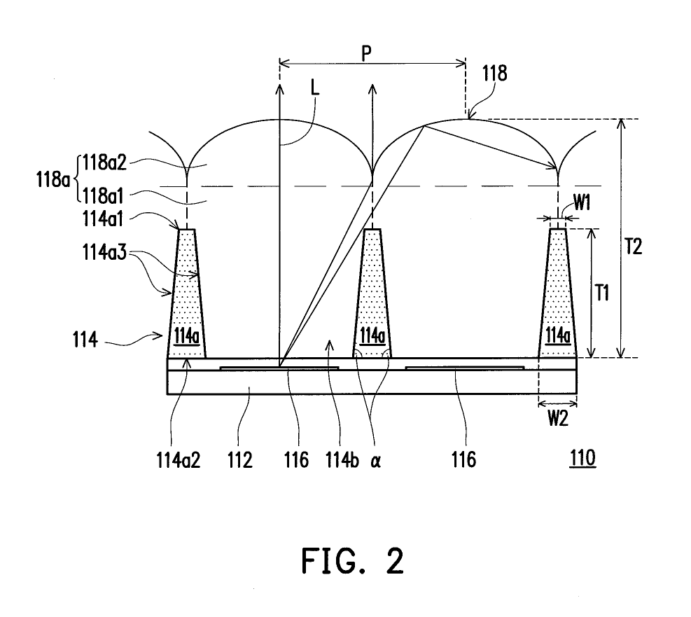

FIG. 2 is a schematic cross-sectional diagram illustrating an LED array light source according to an exemplary embodiment of the disclosure. With reference to FIG. 1 and FIG. 2, the LED array light source 110 includes a substrate 112, a meshed light-shielding layer 114, a plurality of LED chips 116, and a micro-lens array 118. The meshed light-shielding layer 114 is disposed on the substrate 112 and includes a plurality of bar-shaped light-shielding patterns 114a intersected with one another to define a plurality of openings 114b arranged in array. Each of the bar-shaped light-shielding patterns 114a has a bottom surface 114a2 in contact with the substrate 112, a top surface 114a1, and two side surfaces 114a3, a width W1 of the top surface 114a1 is smaller than a width W2 of the bottom surface 114a2, and a thickness of the meshed light-shielding layer 114 is T1. Each of the LED chips 116 is exclusively located in one of the openings 114b and disposed on the substrate 112. The micro-lens array 118 covers the substrate 112, the meshed light-shielding layer 114, and the LED chips 116 and includes a plurality of micro-lenses 118a arranged in array. Each of the micro-lenses 118a respectively includes a base portion 118a1 in contact with the meshed light-shielding layer 114 and a lens portion 118a2 connected to the base portion 118a1, and each of the micro-lenses 118a is disposed corresponding to one of the openings 114b, respectively. A vertical distance from a top portion (the apex) of each of the micro-lenses 118a to the bottom surface 114a2 is T2, and T1≦T2.

For instance, the thickness T1 and the distance T2 satisfy the following equation:

0.278≦T1/T2≦0.833.

When the thickness T1 and the distance T2 satisfy 0.278≦T1/T2≦0.833, the collimation and the light-emitting efficiency of the LED array light source 110 may be improved.

In the present embodiment, the bottom surface 114a2 is substantially parallel to the top surface 114a1, and an included angle α between each of the side surfaces 114a3 and the bottom surface 114a2 is substantially the same. That is to say, if the bottom surface 114a2 serves as the basis, the two side surfaces 114a3 have substantially the same degree of tilt. Besides, the width W2 of the bottom surface 114a2 substantially ranges from 20 μm to 35 μm, for instance, and the width W1 of the top surface 114a1 substantially ranges from 1 μm to 5 μm, for instance. Note that the included angle α is relevant to the width W1 and the width W2, and the appropriate included angle α may be calculated based on actual design requirement in the disclosure.

According to the present embodiment, the meshed light-shielding layer 114 may be formed in various manner. For instance, the meshed light-shielding layer 114 may be formed through electroforming, stacking and bonding metal films, stencil printing, and so on, so as to obtain the meshed light-shielding layer 114 with the expected thickness.

Here, the pitch P between the lens portions 118a2 substantially ranges from 10 μm to 60 μm, for instance, and a curvature radius of each of the lens portions 118a2 substantially ranges from 5 μm to 60 μm, for instance. In addition, the base portions 118a1 of the micro-lens 118a and the lens portions 118a2 are integrally formed, for instance. Namely, the base portions 118a1 and the lens portions 118a2 are made of the same material. For instance, the micro-lens array 118 may be formed by highly precise mold through injection molding.

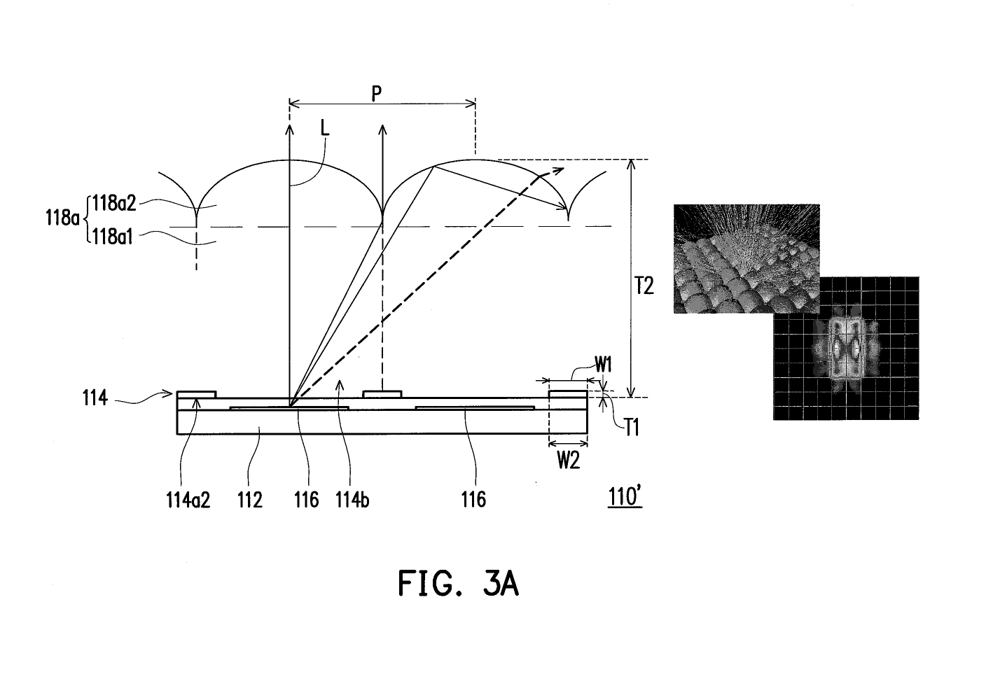

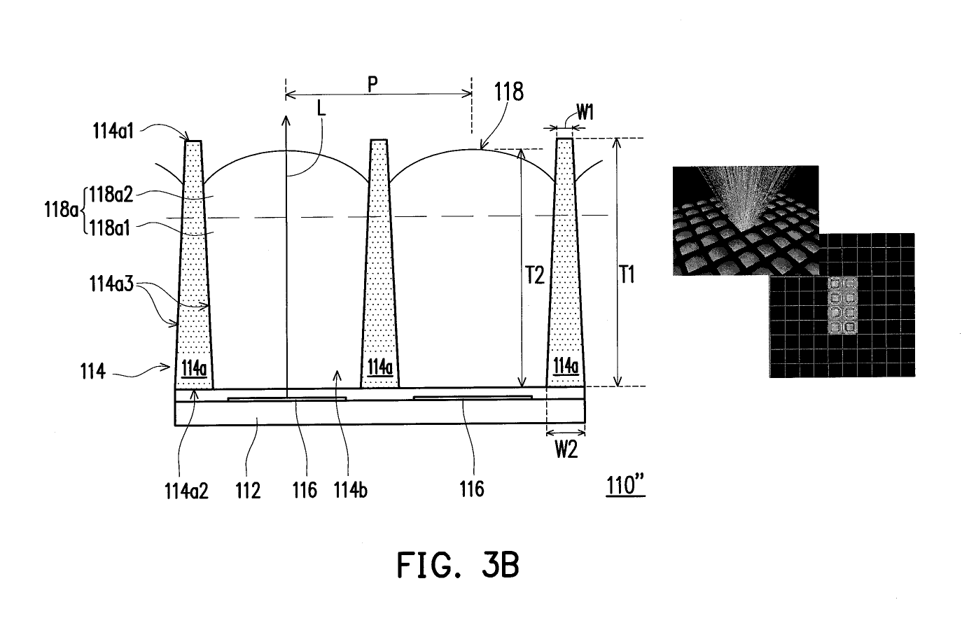

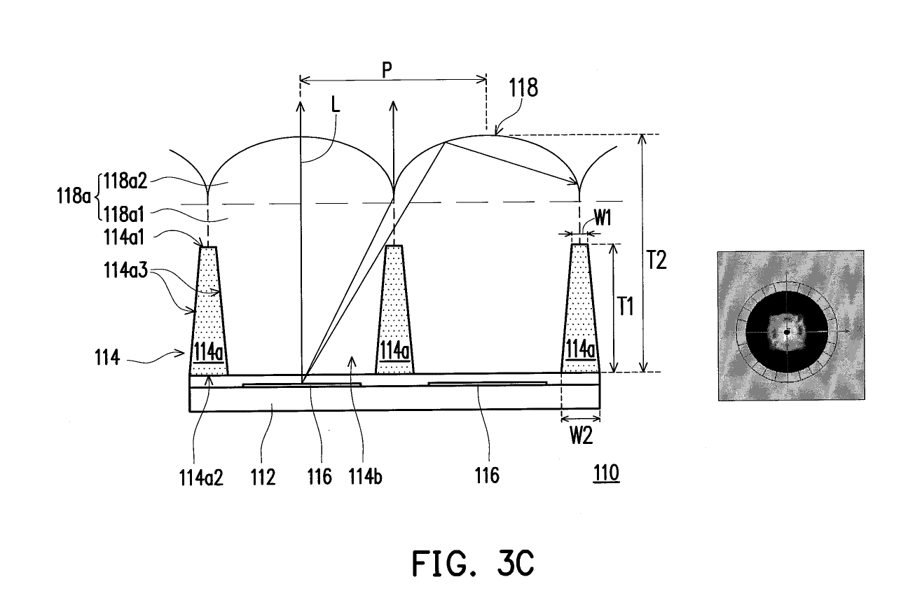

FIG. 3A to FIG. 3C are schematic cross-sectional diagrams illustrating three different LED array light sources. With reference to FIG. 3A, when the thickness T1 of the meshed light-shielding layer 114 is far less than the vertical distance T2 from the top portion of the micro-lens 118a to the bottom surface 114a2 of the bar-shaped light-shielding pattern 114a (T1/T2=0.028), the light-emitting efficiency of the LED array light source 110′ is satisfactory (about 18.7%), while the crosstalk of light beams is rather noticeable, thus resulting in unfavorable collimation (as shown in the right-handed portion of FIG. 3A). With reference to FIG. 3B, when the thickness T1 of the meshed light-shielding layer 114 is greater than the vertical distance T2 from the top portion of the micro-lens 118a to the bottom surface 114a2 of the bar-shaped light-shielding pattern 114a (T1/T2=1.33), the light-emitting efficiency of the LED array light source 110″ is reduced (about 14.0%), while the crosstalk of light beams is restrained, thus improving collimation (as shown in the right-handed portion of FIG. 3B). With reference to FIG. 3C, when the thickness T1 of the meshed light-shielding layer 114 and the vertical distance T2 from the top portion of the micro-lens 118a to the bottom surface 114a2 of the bar-shaped light-shielding pattern 114a satisfy 0.278≦T1/T2≦0.833, the light-emitting efficiency of the LED array light source 110 is favorable (about 18.5%), and the crosstalk of light beams is restrained, thus leading to satisfactory collimation (as shown in the right-handed portion of FIG. 3C).

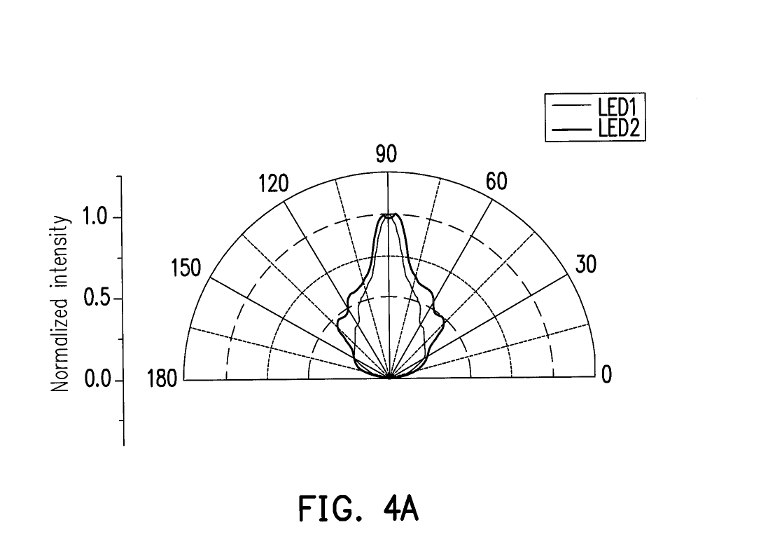

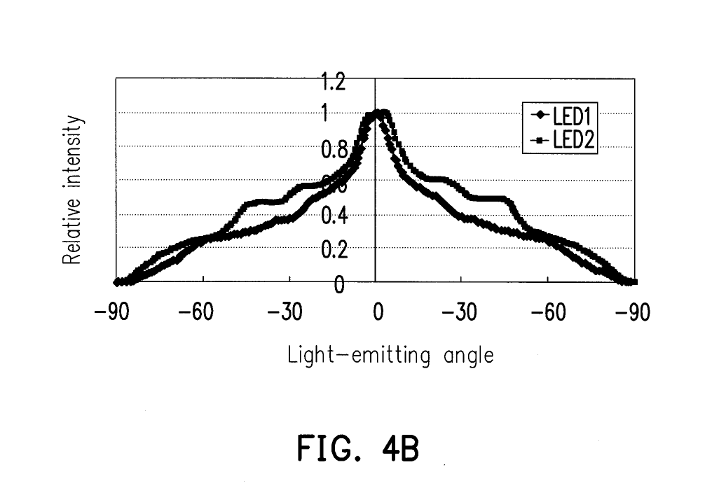

FIG. 4A and FIG. 4B illustrate light intensity distribution in an LED chip according to an exemplary embodiment of the disclosure. With reference to FIG. 4A and FIG. 4B, the light intensity distribution of the LED chips 116 (LED1 and LED2) of the present embodiment is similar to that of the Lambertian-like light source, and the FWHM of the light intensity of the LED chips 116 ranges from 55° to 60° (as shown in FIG. 4B), for instance. Besides, each of the LED chips 116 (LED1 and LED2) of the present embodiment has a photonic crystal structure (not shown), so as to further improve the light-emitting efficiency of the LED array light source 110.

TABLE 1

| | Light-emitting | Light-emitting efficiency | |
|---|---|---|---|
| | efficiency of LED chip | after packaging (FIG. 3C) | Gain |
| Lambertian | 7.2% | 18.7% | 2.58 |
| light source | | | |
| LED 1 | 10.2% | 22.1% | 2.17 |
| LED 2 | 9.0% | 21.3% | 2.35 |

It can be learned from Table 1 that the design concept of the disclosure can significantly help ameliorate the light-emitting efficiency of the LED array light source and is therefore quite applicable to the field of micro-projection.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A light-emitting diode (LED) array light source comprising:
a substrate;
a meshed light-shielding layer disposed on the substrate, the meshed light-shielding layer comprising a plurality of bar-shaped light-shielding patterns intersected with one another to define a plurality of openings arranged in array, wherein each of the bar-shaped light-shielding patterns has a bottom surface in contact with the substrate, a top surface, and two side surfaces, a width of the top surface is smaller than a width of the bottom surface, and a thickness of the meshed light-shielding layer is T1;
a plurality of LED chips, each of the LED chips being exclusively located in one of the openings and disposed on the substrate; and
a micro-lens array covering the substrate, the meshed light-shielding layer, and the LED chips, the micro-lens array comprising a plurality of micro-lenses arranged in array, each of the micro-lenses respectively comprising a base portion and a lens portion connected to the base portion and being disposed corresponding to one of the openings, respectively, wherein a vertical distance from a top portion of each of the micro-lenses to the bottom surface is T2, and 0.278≦T1/T2≦0.833.

2. The LED light source as recited in claim 1, wherein the bottom surface is substantially parallel to the top surface, and an included angle between the bottom surface and each of the side surfaces is substantially the same.

3. The LED array light source as recited in claim 1, wherein the width of the bottom surface substantially ranges from 20 μm to 35 μm, and the width of the top surface substantially ranges from 1 μm to 5 μm.

4. The LED array light source as recited in claim 1, wherein a pitch between the lens portions substantially ranges from 10 μm to 60 μm.

5. The LED array light source as recited in claim 1, wherein a curvature radius of each of the lens portions substantially ranges from 5 μm to 60 μm.

6. The LED array light source as recited in claim 1, wherein the base portions and the lens portions are integrally formed.

7. The LED array light source as recited in claim 1, wherein each of the LED chips has a photonic crystal structure.

8. The LED array light source as recited in claim 1, wherein a full width at half maximum (FWHM) of light intensity peak of each of the LED chips substantially ranges from 55° to 60°.

9. An optical engine comprising:
the light-emitting diode (LED) array light source as recited in claim 1, the LED array light source providing a light beam; and
a projection unit disposed on a transmission path of the light beam, wherein a light-receiving half angle of the projection unit is approximately 15°.

10. The optical engine as recited in claim 9, wherein the bottom surface is substantially parallel to the top surface, and an included angle between the bottom surface and each of the side surfaces is substantially the same.

11. The optical engine as recited in claim 9, wherein the width of the bottom surface substantially ranges from 20 μm to 35 μm, and the width of the top surface substantially ranges from 1 μm to 5 μm.

12. The optical engine as recited in claim 9, wherein a pitch between the lens portions substantially ranges from 10 μm to 60 μm.

13. The optical engine as recited in claim 9, wherein a curvature radius of each of the lens portions substantially ranges from 5 μm to 60 μm.

14. The optical engine as recited in claim 9, wherein the base portions and the lens portions are integrally formed.

15. The optical engine as recited in claim 9, wherein each of the LED chips has a photonic crystal structure.

16. The optical engine as recited in claim 9, wherein a full width at half maximum (FWHM) of light intensity peak of each LED chip substantially ranges from 55° to 60°.
